(19) United States
(12) Patent Application Publication
(10) Pub. No.: US 2011/0045218 A1
(43) Pub. Date: Feb. 24, 2011

(54) DYNAMIC INKS AND COATINGS

(76) Inventors: Nancy L. Harper, Bridgewater, NJ (US); Keith W. Donaldson, Buffalo Grove, IL (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/545,187

(22) Filed: Aug. 21, 2009

(51) Int. Cl. B32B 1/06; B32B 1/02

(52) U.S. Cl. 428/34.2; 428/34.1; 428/36.6

(57) ABSTRACT

Harmful chemicals and/or organisms are neutralized or reduced in concentration by reaction with a protective chemical applied thinly as a coating on a surface facing the internal volume of an enclosure that can contain a product to be protected. The surface can be the inward surface of an enclosure or an included sheet or other item within the enclosure, optionally adhered to the enclosure or to the product. Exemplary protective chemicals include particulate copper and silver, especially as metal flakes, sized to correspond to the pigments in an ink. The protection is normally sufficient with about 10% of the particle surface area exposed, or in an enclosure that is incomplete or foraminous, a higher concentration can be employed or the protection can be shorter lived.

### BACKGROUND

This disclosure relates to the field of compositions, methods of application and materials, useful for neutralization of air borne reactive chemicals and for suppression of microbes and intrusive organisms such as mold and mildew on surfaces.

Reactive chemicals are sometimes present in environments that are more or less confined, such that the reactive chemicals can have undesirable effects on surfaces exposed to the chemicals. For example, airborne sulfur and chlorine compounds can corrode exposed surfaces or cause staining or other sorts of deterioration. Some materials corrode in the presence of oxygen and humidity. Biologically active effects likewise can occur in the presence of bacteria, viruses and mold spores, the growth of which can have adverse effects, namely to detract from the functionality, reliability, appearance or other aesthetic qualities, and/or the useful life of materials to which they are exposed and if allowed to reproduce will allow the transference of disease, infection, and allergic reactions in other living organisms.

An example of a material in a confined environment is an item that has been packed for storage or shipment. A typical package comprising a whole or partial enclosure, or least a wrapping, effective to exclude one or more chemical or biological influences from entering the confined environment from the ambient. A wide variety of package arrangements are possible. A package can be a thin or foraminous partial wrapping, substantially exposing the contents to ambient light and air, or a hermetically sealed full enclosure made an impervious material. The environment contained within the packaging, to which environment the packaged item is exposed, is more or less exposed to or protected from gaseous and particulate exchange of material with the ambient according to the extent to which the packaging is permeable or unsealed on one hand, versus impermeable, sealed and potentially evacuated or charged with an inert gas on the other.

Packages intended for shipment or storage are one example of a confined environment or atmosphere. Another situation in which structures and materials maintain a more or less isolated atmosphere is a space within a building, wherein structural surfaces isolate the interior space of rooms from the exterior and from one another. The surfaces of items within a room are exposed to the indoor atmosphere and isolated from adjacent rooms and from the outdoors. Similarly, fixed and movable cabinets, lockers, boxes and containers in general can provide an atmosphere. Such containers serve to confine gas, vapor, particulates and the like within the container and exclude gas, vapor and particulates from outside the container, to an extent that is determined by the nature of the material that forms the container or enclosure and the completeness of the enclosure that is provided.

For limiting the humidity within an enclosure, it is possible to place a quantity of desiccant material inside the enclosure together with an item to be protected from humidity. If the package is well sealed, the desiccant sequesters whatever water vapor was originally in the isolated environment. If the package is not well sealed, the desiccant can absorb water vapor that diffuses into the environment for a time and eventually is used up and becomes ineffective. Water vapor is a reactive chemical in a sense, because surfaces exposed within a package may oxidize in the present of water vapor. If the internal environment within a package is damp and exposed surfaces are composed and structured of materials that support biological growth, mold spores or mildew can result.

It is common to employ watertight sheet packing materials such as plastic sheets forming bags or envelopes, to isolate the contents of a package. Amendments can be incorporated into sheet packing material. The material can be made opaque by adding an opaque particulate material. If the added particulate is conductive and in a functionally sufficient concentration, the package can be made conductive to control problems with static electricity. One conductive powder used for this purpose is carbon black.

Certain elemental particulate powders can also be incorporated into sheet materials with biocidal and/or algaecidal effects, such as copper and silver. A variety of sheet materials incorporating amendments for countering chemically reactive gases in the atmosphere, and for suppressing the growth of mold and mildew, are known. Packaging and packaging materials with such properties can be obtained, for example, from Engineered Materials Incorporated, 113 McHenry Rd., Suite #179, Buffalo Grove, Ill. 60089. These products protect enclosed surfaces from exposure to ambient reactive gases that come into contact with the exterior of packages formed with such materials, and from the growth of molds or fungus. Several such products are known to intercept the ingress of reactive chemicals or the like, by providing both a hermetic barrier against ingress, and also exposing chemical species that react with the reactive chemicals, e.g., neutralizing acids or bases or producing salts whereby chemical gases, vapors and aerosols are sequestered or rendered less harmful.

Any material defining an enclosure will deteriorate with age and exposure. Elements in the ambient air, temperature cycling, cycles of moisture and drying, ultraviolet light, mechanical tension, flexing, abrasion, etc., all take a toll. Also, different materials may be more or less permeable to gas diffusion or subject to wetting and capillary migration of fluids through the packaging barrier. Packaging materials available from Engineered Materials Incorporated can include so-called “Intercept” elements and compositions, for example including copper or silver powder or other compositions, dispersed through the thickness of packaging sheets, where such compositions can react with gases that may diffuse through a packaging sheet or liquid that may migrate through the barrier defined by the packaging sheet.

In the case of dispersed intercept composition, a relatively higher concentration of the additive ingredient that has the functional effect of reacting with an intrusive chemical, presumably has a stronger functional effect than a lower concentration. Thus, if particles of copper or silver are incorporated into polymer sheet packaging as biocides or as sacrificial reactive elements with a relatively higher concentration, one might expect a better degree of protection for an item carried in the packaging, than would be obtained at a lower concentration. Likewise, making the sheet packaging material thicker should improve the protection, both initially and with deterioration. But using more material in a thicker sheet and/or using more additive material in the sheet, increase the cost of the packaging product. As the concentration of particulates dispersed in a sheet material is increased, the material characteristics of the sheet, such as structural strength and permeability, can be adversely affected. In order to maintain comparable strength and permeability characteristics in a material with a higher additive concentration, the material thickness may need to be increased. These changes increase the total cost of the packaging.

What is needed is a way to optimize the use of reactive chemical neutralizing agents and biocidal suppressants, i.e., to achieve a robust functional effects at modest cost, and preferably with minimal disruption or added steps required in the structure of packaging for items to be protected, or in steps used the protected items themselves.

### SUMMARY

It is an aspect of the present disclosure to take a fresh approach to the problems associated with the production and application of packaging materials and packages and other enclosures generally. This approach may be considered thinking “inside” the box: Rather than embodying packaging material to intercept the inward diffusion or dispersal of unwanted chemicals, an alternative technique is to expose protective materials on surfaces within the zone or volume to be protected, namely in the internal volume of a package, enclosure, cabinet or even surfaces in a wholly or partly closed room. This approach typically produces a comparable degree of protection for items disposed in the internal volume, while typically using a relatively smaller amount of active protective composition (such as elemental metal copper or silver powder in the case of biocidal effect, or other such protective compositions). A relatively thin application of the protective material, preferably applied in a way that maximizes surface exposure, generally can suffice. The amount of the exposed protective material can be made relatively greater to accommodate a less hermetic enclosure or one requiring effective protection for a longer time, or can be less (i.e., a thinner application) if the enclosure is tight and well sealed. It is an object of this disclosure to establish techniques for sacrificial reaction and sequestration of harmful chemicals and/or interference with the metabolism or reproduction of microbial flora or fauna, using a surface application of an ink or coating containing the protective material.

Another object is to produce methods of application and compositions that when applied by such methods have salutary results with respect to protection of typical packaged products and suppression of typical microbial species. Accordingly, techniques for obtaining effective ranges of particulate concentration for the protective material are disclosed based on the carrier employed and the character and dimensions of particulates entrained with the carrier for application. A further object is to relate the protective carrier application to the character of the surface, for example wherein surface irregularities affect the optimal nature of application.

In exemplary arrangements, the protective material can comprise elemental copper, silver or another metal or material or combination thereof, preferably in a particle flake form wherein the particle dimensions are comparable to pigment particles in an ink or similarly thin coating, and wherein the protective material is applied with a carrier having a setting or volatile component that after curing or evaporation exposes a sufficient particle surface area to obtain surface contact and consequently to react with harmful chemicals and microbes. A further object of the disclosure is to provide a range of particle characteristics and carriers to achieve such exposure while also enabling a certain degree of diffusion and dispersion of metal ions and metal particles over the surface facing into a protected space. The protective material can be applied by printing and coating techniques, by spray or atomization, by flow, by contact with a roller, brush or pad, etc.

A reactive chemical might be confined originally within a closed package or might find its way from the outside into a “closed” package through gaps in the packaging or by diffusion through the packaging material. For example, water vapor may have been captured inside a package when the package is first closed, or the internal volume of a package may assume the ambient humidity level over time by diffusion. A reactive chemical or fungal spore can be trapped inside a package or find its way into a package in a similar way. A reactive chemical might also evolve inside a package due to a chemical reaction within the packaged product. If the packaging material exposes a complementary chemical specie on its internal surfaces, which specie reacts with the reactive chemicals inside the package, then the reactive material can be neutralized, sequestered or suppressed within the package, at least until the complementary specie is consumed. What is needed is to expose a sufficient amount of the chemical specie for reaction, and to provide a way to facilitate contact between the chemical specie and the harmful chemical or agent.

The disclosed coating compositions and techniques are not limited to use with an enclosure or envelope, and additionally are applicable as a coating composition for a product in an enclosure or for a limited surface that is exposed within an enclosure. The coating composition can be embodied as the exposed surface of a lamination, as a coating that is applied directly to an article to be protected, as a coating on an item that is placed inside an uncoated enclosure, as well as being a coating on an inward facing surface of an enclosure. As an inward facing surface coating, the disclosed material forms a barrier coating or layer that impedes harmful chemical reactants such as atmospheric gaseous contaminants. As an included surface, the coating functions as a getter to react with, immobilize and thereby neutralize and sequester undesired reactive compositions.

An item enclosed in a complete or partial package comprising a coating or included coated surface is protected to a degree or for a time that is a function of the amount and composition of the coating, the integrity of the envelope that the package provides, the concentrations of the included and ambient reactive chemical or undesired microbe composition, and the rate at which there is an exchange (if any) with the ambient. It should be understood that the disclosed coating compositions and techniques are not limited to complete enclosures with maximized protective coating, but also are applicable to varying degrees of lesser protection.

According to another aspect, an object of the disclosure is to produce a protective coating in a form characterized by a relatively high ratio of total exposed active surface area per unit of sheet area. This can be accomplished in one or more of several ways including by the structure of the coating material to leave on the coated surface an aggregate with active particles partially exposed and protruding from the carrier after curing or evaporation of volatiles. The carrier functions to adhere the particles to the coated surface, and provides a medium in which ions can be dispersed. In other respects, the carrier is composed to leave a layer that is thin compared to the thickness of the protective particles. The particles protruding from the coating provide an irregular surface with a good ratio of exposed particle area to unit of surface area. This ration can be enhanced if the surface is irregular before it is coated, for example as in the case of an embossed or roughened surface or open cell foam.

The coating comprising particles of a protective element or composition (such as silver or copper particles) of a particle size comparably to that of pigment particles in an ink or paint. The coating can be produced with the viscosity of a thin ink or varnish or paint, and then can be applied in the same way, namely with a dip or flow, spray, printing by a roll or other contact technique, brushing, etc. As another alternative, the particles can be treated to render them tacky or entrained with thermoplastic particles and electro statically adhered as a powder coating that adheres more permanently after heating.

A number of additional aspects and alternatives will be made apparent by the following discussion of specific examples and alternatives, which should be regarded as exemplary rather than limiting and subject to use individually or in combination of their aspects.

### BRIEF DESCRIPTION OF THE DRAWINGS

Several examples are shown in the drawings for illustrating the concepts of this disclosure. The invention is not limited to the embodiments shown as examples. Reference should be made to the appended claims to assess the scope of exclusive rights. In the drawings,

FIG. 1 is a figurative illustration showing an enclosure subject to ambient conditions, protecting an article in an internal volume, by action of a protective composition carried on an internal surface of the enclosure.

FIG. 2 is a schematic illustration of an embodiment wherein an at least partial enclosure permits permeation of an airborne chemical or species composition; and wherein the protective composition is arranged to counteract the chemical or species within the enclosure, in particular comprising particulate material exposed on a surface of a coating.

FIG. 3 is a figurative illustration of an enclosure as in FIG. 1, wherein the protective composition is carried on an article within the enclosure, such as, without limitation, an article to be protected from a chemical or specie.

FIG. 4 is a schematic illustration demonstrating an irregular surfaces bearing a protective composition, whereby the surface area of the surface is greater than its footprint.

### DESCRIPTION AND REPRESENTATIVE EXAMPLES

According to the disclosed technique, a protective material is exposed in a defined space, such as within a package or enclosure. The protective material is reactive with an unwanted element, compound or mixture of chemicals that is found within the enclosure, or the protective material can be a material that interacts with unwanted biological flora or fauna that are found within the package or enclosure. By virtue of exposure to the protective material, the unwanted element, compound or mixture is rendered less harmful, for example less reactive, the unwanted element, compound or mixture is affixed in place and thereby sequestered. In the case of unwanted biological flora or fauna, the protective material can comprise a biocide that eliminates the unwanted flora or fauna, or can simply interfere with the flora or fauna to minimize the extent to which the flora or fauna produces unwanted effects. Thus, for example, the protective material interferes with the metabolism of the flora or fauna or the ability of the flora or fauna to reproduce.

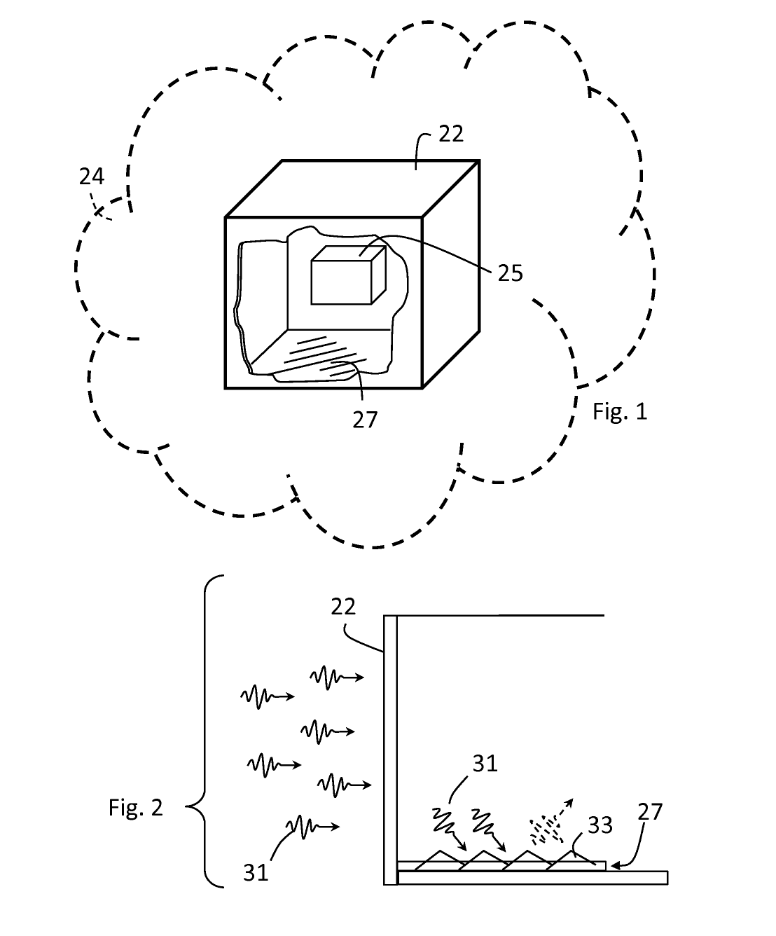

In FIG. 1, an enclosure is generally illustrated by a box 22 disposed in the volume of a cloud 24 representing ambient conditions, and protecting an article 25 in the internal volume of the enclosure. Protection is provided by action of a protective composition carried on an internal surface 27 facing into the internal volume of the enclosure.

The protective material is applied to exposed surfaces in a concentration and in an amount sufficient to obtain at least a partial or temporary protective effect. The particular concentration of protective material and the amount of surface area at which the surface area is exposed determines the availability of the material and its effectiveness. The concentration and surface area can be made relatively greater or less to account for a higher or lower concentration of the unwanted chemical or biological effect, or a relatively discontinuous or continuous enclosure (affecting the rate at which the outside ambient may continue to introduce the unwanted chemical or effect), and/or to maintain an effective threshold of protection for a longer or shorter time, respectively. The examples set forth in this section of the disclosure are intended to be illustrative and do not preclude the use of higher concentrations or surface areas where a greater or longer lasting effect is desired, or the use of lower concentration or smaller surface area in a less demanding application.

FIG. 2 is a schematic illustration of an embodiment wherein an at least partial enclosure permits permeation of an airborne chemical or species composition 31; and wherein the protective composition is arranged to counteract the chemical or species within the enclosure, in particular comprising particulate material 33 exposed on a surface of a coating 27.

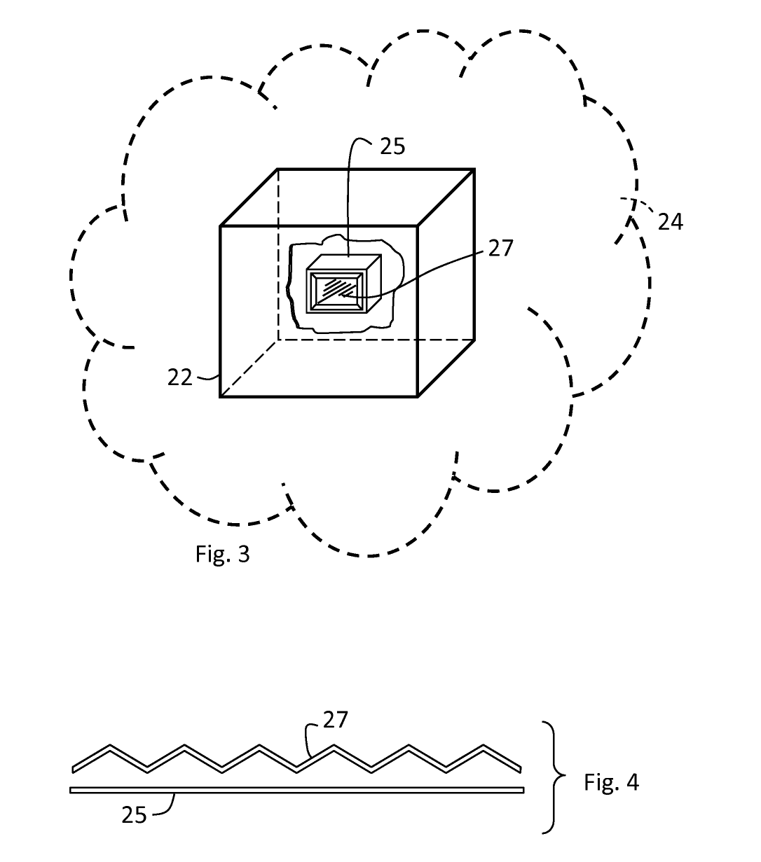

In FIGS. 1 and 2, the protective composition or coating 27 is disposed on an inwardly facing surface of the enclosure 22. FIG. 3 shows that the protective composition can be carried on a surface of an article that is placed within the enclosure, such as the article 25 that is to be protected, or on the surface of another article such as an insert or internal layer of packing material.

According to one embodiment, a protective composition comprises an active element in a particulate form, for example with a portion of the surface of active particles 33 protruding from a carrier forming the coating 27, for example as shown in FIG. 2. In any event, an active element or composition or combination is entrained with a carrier for application to a surface facing inwardly or exposed within an enclosure. The active element can be chosen from the group consisting of elements having a partially filled d or f sub-shell in any common oxidation state or in combination with other elements, preferably such that the ensuing compound contains easily transferred electrons. Typical active elements are high melting point metals. They may have several oxidation states. They usually form colored compounds and are often paramagnetic.

Some of the elements and their oxides are: elemental silver, platinum, gold, copper, aluminum, zinc, chromium, iron, cobalt and their oxides. Additional compounds comprised of the initial elements can also be used if they have a partially filled outer shell so there are free electrons available for easy exchange. Suitable carriers can be chosen from the list consisting of acrylates, liquid polymer suspensions, alkyds, epoxies, varnishes, shellacs, and other carrier materials. The composition can be applied in a range up to 100% solids (i.e., no volatiles) in the case of a power coating that is adhered, for example, by electrostatic coating and heated to adhere.

In an exemplary embodiment, a solution of copper particulates in a range of 2.0 to 50 microns particle size (2.0 to 50×10⁻⁶ m) is entrained in a volatile carrier, preferably comprising alcohol or water and optionally one or more adherent compound such as wood pulp varnish or a combination thereof. The particulates can amount to 5% to 30% by weight, for example.

A preferred particle is in a distribution of 5.0 to 20 microns, or more preferably about 15 microns mean particle size. The particle sizes can fall in a distribution, for example with a larger proportion (e.g., 75% to 90%) falling in a certain range of sizes (e.g., 5.0 to 30 microns) and having a statistical mean size (e.g., 5.0 to 7.0 microns). The particles can be in a crystalline, rounded particle or other fine powder form, or can be fine flakes.

Copper, silver and other particulates in the noted size range are available, for example, from Ferro Corporation, South Plainfield, N.J. Although submicron particle sizes are also available, it has been determined that an advantageous proportion of surface exposure can be obtained by applying the protective material in a particle size distribution that includes a substantial particle population in the range of about 10 microns, in a carrier that when cured or after evaporation of volatiles is sufficiently thin that the ratio of exposed metal surface area to coated surface area is relatively high. This ratio is partly due to the thickness of the cured carrier and the shape and dimensions of the particulates. For example, generally spherical particles of approximately 10 microns diameter protrude with respect to an adherent coating that is applied as a thin coating such as an ink formulation, providing a substantial portion of exposed particle surface. In the case of particles in a flake shape, the orientation of certain particles in an agglomeration is such that particle surfaces are exposed. In one possible arrangement, the exposed surface area of the protective particles is arranged to total about ten percent (10%) of the surface area of the surface that is coated. In the case of copper particulates in a carrier, this extent of exposed protective material has a beneficial antibacterial effect and suppresses the development of mold and mildew.

Elemental copper provides a biostatic effect on surfaces. Copper sulfate is useful as a fungicide and as an algae control agent. Silver nitrate is a known disinfectant. Elemental silver ions in concentrations from 10-200 micrograms per liter are effective to deactivate the reproduction of certain bacteria such as e.coli. These and similar compounds are known to suppress lysteria and staphylococcus. It is an aspect of the present disclosure that an effective but minimal application of a biocidal composition is applied to a surface that is exposed to the atmosphere within an enclosure, so as to provide a protective effect.

In an embodiment found effective to suppress microbes, copper flake particles of 7 to 17 microns on a side and of smaller thickness, e.g., 0.5 microns, namely of a particle size that might be used for application of a pigment, were applied to exposed surfaces by one of printing by contact roller or pad, by spray or inkjet application, by immersion or liquid wave flow or another known technique for application of an entrained particulate.

In an exemplary embodiment for the use of a covering of a solid rigid surface a clear acrylate sheet can be roller coated with the specific ink made from a solvent based carrier and placed on the top of the counter surface in order to provide a handling area to control the propagation of salmonella from one type of food to another. A second embodiment uses a thin (<0.001″) sheet of stretchable polymer that is spray coated with the liquid coating. The prepared sheet is then stretched over benches in a locker room to provide an anti-microbial surface to control the spread of skin borne bacterium. A third embodiment coats a polymeric shower floor with an epoxide version of the invention to prevent the support of fungi strains that cause athlete's foot type diseases. A fourth embodiment uses a water based varnish carrier type of mixture to coat open cell polymer foam filter media to inhibit the growth of air borne fungi and mold spores. comprising a substantially hermetically sealed enclosure containing a preferred coating offers, an effective degree of protection against corrosion, mold growth, fungal growth, thus protecting the article placed in the enclosure from corrosion, discoloration and disturbances in reflectivity from the above sources of degradation. can be obtained by a ratio of ½ of area of exposed protective coated material protected surface area, wherein the protective composition is in the same enclosure of close proximity, or direct contact with the article.

The protective material, comprising a distribution of particles in a carrier, can be applied directly and generally over the full surfaces of the item to be protected. Alternatively, the protective material can be applied in discrete locations so as to resemble printed ink applications wherein the application is limited or discontinuous, preferably such that the composition is covering a minimum of 33% of the surface area and that area of coverage has a maximum spatial distance of 30 microns. Less spacing and/or a higher ratio of surface area is generally more effective. Accordingly, as shown in FIG. 4, the protective material 27 can be carried on an irregular surface such as a corrugated surface, to provide an exposed surface area that exceeds the outer dimensions or footprint of the inserted article or of a protected article 25.

According to an advantageous aspect, the protective particulate component is preferably exposed rather than being encapsulated by the carrier. For this purpose, the carrier can applied in a thickness of <90% of the particulate mean length. For instance if the particulate is 15 microns then the coating should be no greater than 13.5 microns thick. Another technique is to use an electrostatic powder paint which when heated to cure will allow the particulate to rise to the surface of the paint and with the particles oxide will nor wet well and be exposed to the environment. There are also pressure differential parameters that when spray of roller coating can be adjusted to bring the particulate to the surface. While it is more efficient to have the particulates come closer to the surfaces rather than the bulk thickness of the coating carrier it will still work to a lesser degree if the particulates are imbedded <10% of the particles mean thickness into the carrier surface. If applied as paint, the material can encompass a surface in liquid form upon application or electro-statically applied in powder form wherein the particulate constituents are melted under heat or radiation and caused to flow or to bond at points of contact, at a later time. The material can be applied generally or in masked patterns or areas. These areas can be placed strategically on a product, for example to protect a vulnerable surface area where a particular material is exposed or where there is a clearance gap for air flow or diffusion of materials.

In one embodiment, these reactive inks and coatings are applied directly to surfaces, and in other embodiments the inks and coatings can be applied to media such as paper, plastic, wood, metal, fabric or other material surfaces. These surfaces can comprise temporarily-adhered or permanently-adhered covers, or permanent structures such as an enclosure for static environments that may envelop items or surfaces to be protected and be wholly or partly sealed. In another embodiment a coated material such as paper based sheets that are wrinkled to provide impact and open space reduction (such as a box containing a article) used as packing would be in close contact to the article being protected and provide the article with corrosion and anti-microbial protection.

According to another embodiment, a predetermined ratio of protectively coated surface area to total surface area can be obtained under constraints respecting available space. For example, a package inner surface, or a package insert or an inside wrapping or other exposed surface within an at least partial enclosure can be coated with protective material occupying a surface area that is greater than the outside dimensions of the protectively coated surface, by causing the protective coating to reside on an irregular surface instead of a flat surface. Thus, for example, a surface bearing the protective composition can be embossed to provide an irregular surface. A sheet bearing the protective composition can be corrugated as shown in FIG. 4.

In another embodiment wherein surface area is maximized within constraints on outer dimensions, the protective coating is applied to all or a part of a foam, fabric, non-woven batten type material such as a filter media, or another media that has a high surface area to space ratio can be provided to protect items and surfaces in an at least partially confined environment. In these embodiments, the surface area presents protective compositions at the surface in close proximity with the potentially harmful or reactive materials of nearby gas or particulates in the ambient air, facilitating reactions that neutralize or sequester the harmful or reactive materials.

Typical ratios of surface area of the protector to the surface area of articles needing protection is ½. This ratio is given for a flat sheet being used to wrap and article in a static closed environment. This ratio can be reduced as a function of actual surface area of the material being manufactured for coating such as ridges, irregularly edged depressions, punch depressions, closed cell foam etc. An example of this would be a coated embossed sheet having a surface area of 2 cm²/cm² will need a typical area of ¼ of protection sheet for this type of application.

In addition to employing copper and/or silver for biocidal effects, the protective composition can be include materials that neutralize ambient chemical species, for example to ameliorate acid or basic chemicals by moderating the pH of such chemicals in a reaction that reduces the corrosive or caustic effects of the chemicals. As discussed above, a protective material can also operate to sequester an unwanted material for example as a desiccant absorbs and sequesters water vapor.

Where a protective neutralizing chemical is included to balance an unwanted chemical effect (such as an acid to neutralize a base or vice versa), the chemical balance and concentration or amount are preferably exactly sufficient to counteract the harmful chemical, and where possible to avoid an unwanted chemical effect of an opposite nature. Preferably, the interaction of the harmful chemical and the neutralization chemical is a non-harmful reaction product or a sequestered harmful product. The equal and opposite nature of the neutralization chemical versus the harmful chemical is partly a matter of efficiency (not to provide an excess) and partly a matter of preventing a remaining concentration of neutralization chemical that may be harmful in its own context.

In the case of one or more live organisms as the harmful agent(s), or perhaps as the source of a harmful agent or chemical, the neutralizing chemical can be selected for the emission or availability of ions that affect the vitality of the organism (e.g., its processes of respiration, metabolization, etc.) or interrupt functions associated with its harmful effects. For example, a neutralization chemical as disclosed herein, provided in an effective amount, can obstruct the ability of an organism to reproduce, or at least reduce its rate of reproduction. Attrition then reduces or eliminates the population and the threat that the organism may impart. This applies to various organisms and threats. For example, ambient mold spores can lead to material staining due to growth of mold and fungi, material degradation from interstitial tendrils, adverse reactions from chemical products produced by the metabolism of the organism, etc. All of these can be prevented or retarded by suppressing the activity of the spores. Other examples of organisms representing threats include bacterial or viral pathogens that may be neutralized or sequestered with compositions defined herein.

Among other possibilities, the chemical reactions involved in neutralization or sequestration of harmful chemicals and/or the suppression of biologicals can involve, for example, the making or breaking of chemical bonds, oxidation, reduction, dissociation, acid-base neutralization and molecular rearrangement.

In certain exemplary reaction embodiments, the basis for the protective reaction follows rules of synthesis, decomposition, single displacement, double or other plural displacement and/or acid/base.

A synthesis reaction is when two or more simple compounds combine to form a more complicated one. These reactions come in the general form of:

A+B→AB

One example of a synthesis reaction is the combination of iron and sulfur to form iron (II) sulfide:

8 Fe+S₈→8 FeS

A decomposition reaction is the opposite of a synthesis reaction—a complex molecule breaks down to make simpler ones. These reactions come in the general form:

AB→A+B

One example of a decomposition reaction is the electrolysis of water to make oxygen and hydrogen gas:

2 H₂O→2 H₂+O₂

Single displacement occurs when one element trades places with another element in a compound. These reactions come in the general form of:

A+BC→AC+B

One example of a single displacement reaction is when magnesium replaces hydrogen in water to make magnesium hydroxide and hydrogen gas:

Mg+2 H₂O→Mg(OH)₂+H₂

Double occurs when the anions and cations of two different molecules switch places, forming two entirely different compounds. These reactions are in the general form:

AB+CD→AD+CB

One example of a double displacement reaction is the reaction of lead (II) nitrate with potassium iodide to form lead (II) iodide and potassium nitrate:

Pb(NO₃)₂+2 KI→PbI₂+2 KNO₃

An acid-base reaction is a special kind of double displacement reaction that takes place when an acid and base react with each other. The H+ ion in the acid reacts with the OH— ion in the base, causing the formation of water. Generally, the product of this reaction is some ionic salt and water:

HA+BOH→H2O+BA

One example of an acid-base reaction is the reaction of hydrobromic acid (HBr) with sodium hydroxide:

HBr+NaOH→NaBr+H₂O

### EXAMPLES

According to examples now described, neutralizing chemicals are placed in the path that a harmful agent necessarily follows if coming into contact with a surface under protection. The harmful agent can be a chemical or a combination of chemicals or a biological subject or effect. The progress of the agent can be due to fluid or gaseous flow, by diffusion, osmosis, electrophoresis, biological growth or a similar effect applicable to effect movement of the harmful agent from a source such as the ambient air, in a direction of ingress into contact with surfaces under protection.

An aspect of the protection provided by the disclosed protective products and techniques is that of providing not only a hermetic physical barrier such as a film or coating across an ingress pathway, or forming an enclosure around a protected item, but also providing a protective composition on the surface and dispersed through the material of the barrier, for interaction with a harmful agent in the ambient. The protection afforded by the invention thus offers substantially improved protection.

For interrupting the biological function of harmful live organisms (such as viruses, mold, mildew etc.), the protective composition introduces ionic contamination to organisms disposed across the coated surfaces or infiltrating the material of the barrier. The protective composition interrupts the metabolism and/or reproduction cycles of selected organisms that come into contact with the barrier film or coating.

### General Formulation Information

The surface might be coated with particulates for the neutralization of certain constituents such as copper for sulfur and chlorine based gases along with microbes that are adversely affected by copper, aluminum for the neutralization of chlorine and oxygen, nickel for the neutralization of chlorine, iron for the neutralization of water and oxygen, etc. These particles are contained in the amounts of 2.5 to 33.3 weight percent to solids in a suitable carrier that can be comprised of 100 weight percent solids to as little as 5 weight percent solids. The particle sizes can range from 10 mils to 0.1 microns. Larger and smaller particles can be used but the cost benefit ratio is best achieved in the 0.5 to 50 micron range. The carriers can be flexible as ones that will be used on soft surfaces as well as hardened ones that will be used on stiff materials. It is most important to consider the type of uses that the product will be expected to perform when choosing a carrier. For instance: the carrier for locker room floors may be an epoxy while the carrier for plastic sheet may be a vinyl. Other considerations on the carrier choice can be made by the type of volatiles that will be allowed. In enclosed living areas a water based carrier system may be employed where as on a commercial surface a solvent type carrier may be used.

### Example I

A hermetically sealed rectilinear cardboard box of 254 cm×304 cm×152 cm (10″×12″×6″) with all inwardly facing surfaces is coated to protect an exposed surface of a product in the package. The exposed surface is a paper based book. The protective coating provides free copper, silver etc. ions which neutralize and provide primary protection against the growth of molds and fungi that would feed on the paper based materials, namely by interrupting the reproduction cycle of said species. The paper is coated with a solvent based printing ink with 5% by weight copper and silver particles. The particles have a mean size distribution of 17 microns.

### Example II

A box as in example I above is provided, but without any coating. Instead of coating the box interior walls, a packaging paper coated according to the present disclosure is used to wrap the contents with a ratio of 1/1 surface area of the article to be protected to surface area of the wrapping paper. The wrapping paper can use the same printing ink and formulation as in Example I.

### Example III

Inkjet printer cartridges can be filled with printing inks of the 5 to 30% by weight formulation and these printers can print aesthetically pleasing designs at a low cost to produce papers and plastic sheets or rolls that can be used as described herein to protect surfaces.

### Example IV

Primer paints currently existing to prime and block stains on walls can employ the particulate in typical loadings of 5 to 30 weight percent (W %) to neutralize corrosive gasses emanating from wallboard (overseas manufacturers have flooded the world market with wallboard that creates corrosive environments in structures) and halt the spread of mold inside buildings.

### Example V

100% solids epoxy can be used with the addition of 5 W % silver to coat a concrete shower floor in a dormitory, hospital, prison, etc. This provides for suppression of microbial and fungal growth on the floors.

### Example VI

A 7×20 micron×15 W % copper and/or silver particulate acrylate coating 1.5 mils thick can be applied to the interior cases of electronic equipment. This provides an antimicrobial coated surface that does not support spore growth such as e.coli, and anthrax.

### Example VII

Coated open cell foam can be coated with the printing inks and either dipped and squeegee'd or sprayed with a 30 W % water based ink and used as an active air filtration media in homes and or industrial HVAC applications.

The invention has been disclosed and exemplified by a number of alternative embodiments having aspects that meet the objects stated above. However the invention is not limited to the embodiments disclosed as examples. Reference should be made to the appended claims rather than the foregoing description, to assess the scope of the invention in which exclusive rights are claimed.

What is claimed is:

1. An article of manufacture comprising:
an enclosure that at least partially encloses an internal volume such that diffusion of gas, liquid and air borne material into the internal volume from an ambient outside the internal volume is restricted, whereby conditions in the internal volume and ambient conditions outside of the volume can be different from one another;
at least one surface being defined within the internal volume, wherein the surface within the internal volume bears a protective chemical coating comprising a composition that effectively reacts with at least one of undesired air borne chemical and undesired biological species;
whereby conditions in the internal volume are improved relative to conditions in the ambient by one of neutralization and sequestration of said at least one of the undesired air borne chemical and undesired biological species.

2. The article of manufacture of claim 1, wherein said at least one of the undesired air borne chemical and undesired biological species diffuses into the internal volume from the ambient at a given rate, whereby the protective chemical coating maintains improvement of the conditions in the internal volume relative to the conditions in the ambient for a predetermined time after which time the protective chemical coating has been effectively exhausted.

3. The article of manufacture of claim 2, wherein the enclosure comprises a material through which at least one of gas, liquid and air borne material can pass.

4. The article of manufacture of claim 2, wherein the enclosure comprises material that incompletely encloses the internal volume.

5. The article of manufacture of claim 1, wherein the composition of the protective chemical coating produces a reaction product with said undesired air borne chemical for one of neutralizing the air borne chemical and detaining at least a component of the air borne chemical at the protective chemical coating.

6. The article of manufacture of claim 1, wherein the neutralizing chemical has a different chemical potential than the harmful chemical.

7. The article of manufacture of claim 1, wherein the neutralizing chemical has an opposite chemical potential from that of the harmful chemical.

8. The article of manufacture of claim 1, wherein the surface bearing the protective chemical coating comprises at least part of an inwardly facing surface of the enclosure.

9. The article of manufacture of claim 1, wherein the surface bearing the protective chemical coating comprises a limited part of an inwardly facing surface of the enclosure.

10. The article of manufacture of claim 1, wherein the surface bearing the protective chemical coating is at least part of an inserted item disposed in the enclosure together with a product to be protected.

11. The article of manufacture of claim 1, wherein the surface bearing the protective chemical coating comprises at least one surface of an item disposed within the enclosure together with a product to be protected.

12. The article of manufacture of claim 11, wherein the item disposed within the enclosure together with the product comprises one of an inner wrapping surrounding on the product, and an inner layer within the enclosure.

13. The article of manufacture of claim 12, wherein said one of the inner wrapping and the inner layer is adhered to at least one of the product and the enclosure.

14. The article of manufacture of claim 11, wherein the item disposed within the enclosure together with the product comprises a material chosen from the group consisting of paper, polymer, particulate material, aggregate material, a solution, and a suspension; and wherein the neutralizing chemical is one of coated on and embedded in the inert carrier layer.

15. The article of manufacture of claim 1, wherein the protective chemical coating comprises a particulate material in a carrier, adhered to the at least one surface, and wherein the particulate material is partially exposed to the internal volume.

16. The article of manufacture of claim 15, wherein the protective chemical coating comprises at least one of copper particles and silver particles.

17. The article of manufacture of claim 15, wherein the protective chemical coating comprises flaked particles applied as a fraction of an ink.

18. The article of manufacture of claim 15, wherein at least a portion of the at least one surface having the protective chemical is configured to define a coated surface area that is larger than a perimeter area of the at least one surface.

19. The article of manufacture of claim 18, wherein the at least one surface is part of a sheet that is irregularly shaped by at least one of embossing, corrugation and folding.

20. The article of manufacture of claim 18, wherein the at least one surface is defined by interstitial surfaces of one of a fibrous material and an open cell foam.
